(19) United States
(12) Patent Application Publication
(10) Pub. No.: US 2023/0244132 A1
(43) Pub. Date: Aug. 3, 2023

(54) LIGHT SOURCE DEVICE, PROJECTOR, CONTROL METHOD, AND PROGRAM

(71) Applicant: Sharp NEC Display Solutions, Ltd., Tokyo (JP)

(72) Inventors: Sota HIRAHARA, Tokyo (JP); Masateru MATSUBARA, Tokyo (JP)

(21) Appl. No.: 18/011,945

(22) PCT Filed: Jun. 25, 2020
(86) PCT No.: PCT/JP2020/024995

§ 371 Date: Dec. 21, 2022

(51) Int. Cl. G03B 21/20

(52) U.S. Cl. CPC G03B 21/204; G03B 21/2066; G03B 21/208; G03B 21/2053

(57) ABSTRACT

A light source device includes a light source unit that emits monochromatic light, a reflection plate that reflects a part of the emitted light from the light source unit, a holding unit that holds the reflection plate so as to be movable in a direction intersecting the optical path of the emitted light, and a control unit that moves the reflection plate to adjust the quantity of the reflected light that is the part of the emitted light reflected by the reflection plate.

### TECHNICAL FIELD

The present invention relates to alight source device, a projector, a control method, and a program.

### BACKGROUND ART

Patent document 1 describes a light source device that includes a blue laser, a dichroic mirror, a diffusion plate, and a phosphor wheel. The dichroic mirror is provided with a total reflection region in a central portion thereof. In the dichroic mirror, a region (wide-area characteristic region) other than the total reflection region is configured to transmit blue light and reflect yellow light. The dichroic mirror is disposed on the optical path of the blue laser. The diffusion plate is arranged on one surface side of the dichroic mirror. The phosphor wheel is arranged on the other surface side of the dichroic mirror.

The blue light emitted from the blue laser enters the dichroic mirror. In the dichroic mirror, the total reflection region reflects a part of the blue light toward the diffusion plate. The remainder of the blue light is transmitted through the wide-area characteristic region and enters the phosphor wheel. The diffusion plate reflects and diffuses the blue light. The phosphor wheel is excited by the blue light and emits yellow fluorescent light. Blue light, which is composed of diffused light, is incident from the diffusion plate to one surface of the dichroic mirror. Yellow light, which is made up of fluorescent light, is incident to the other surface of the dichroic mirror from the phosphor wheel. The dichroic mirror synthesizes and emits blue light and yellow light on one optical path. The emitted light of the dichroic mirror is the output light of the light source device.

### PRIOR ART DOCUMENTS

### Patent Document

Patent Document 1: JP-A-2019-133080

### DISCLOSURE OF THE INVENTION

### Problems to be Solved by the Invention

In the light source device described in Patent Document 1, the dichroic mirror acts to divide light emitted from the blue laser into two light beams, these being reflected light and transmitted light. Due to individual differences between the optical elements and due to errors in the mounting positions of the optical elements, the quantity of reflected light may vary, and the color of the output light of the light source device may change. However, in the light source device described in Patent Document 1, the quantity of reflected light cannot be adjusted, and therefore it is difficult to suppress changes in the color tone of output light.

An object of the present invention is to solve the above problems and to provide a light source device, a projector, a control method, and a program capable of adjusting color tone of output light.

### Means for Solving the Problem

In order to achieve the above object, a light source device of the present invention includes:

a light source unit that emits monochromatic light;

a reflection plate that reflects a part of emitted light of the light source unit;

a holding unit that holds the reflection plate so as to be movable in a direction intersecting an optical path of the emitted light; and

a control unit that moves the reflection plate to adjust a quantity of reflected light that is the part of the emitted light reflected by the reflection plate.

A projector of the present invention includes the above-described light source device, an optical modulator that modulates the emitted light of the light source device to form an image, and a projection lens that projects an image formed by the optical modulator.

A control method of the present invention is a method of controlling alight source device that includes a reflection plate that reflects a part of emitted light from a light source unit that emits monochromatic light, wherein the reflection plate is moved in a direction intersecting an optical path of the emitted light, the method comprising:

measuring a quantity of reflected light that is the part of the emitted light reflected by the reflection plate; and

moving the reflection plate such that a measured value of the quantity becomes a predetermined value.

A program is configured to cause a computer of a light source device that is provided with a reflection plate that reflects a part of emitted light from a light source unit that emits monochromatic light wherein the reflection plate is moved in a direction intersecting an optical path of the emitted light, to execute the steps of:

measuring a quantity of reflected light that is the part of the emitted light reflected by the reflection plate; and

moving the reflection plate such that a measured value of the quantity becomes a predetermined value.

### Effect of the Invention

According to the present invention, the color tone of output light of the light source device can be adjusted.

### BRIEF DESCRIPTION OF THE DRAWINGS

FIG. 1 is a block diagram showing the configuration of a light source device according to a first embodiment of the present invention.

FIG. 2 is a block diagram showing the configuration of a light source device according to a second embodiment of the present invention.

FIG. 3A is a schematic diagram illustrating an example of a reflection plate.

FIG. 3B is a cross-sectional view of the reflection plate shown in FIG. 3A.

FIG. 4 is a schematic diagram illustrating an example of a phosphor wheel.

FIG. 5 is a schematic diagram showing an example of a reflection plate that has a through-hole.

FIG. 6 is a perspective view schematically showing the moving direction of the reflection plate.

FIG. 7 is a flowchart showing a procedure for controlling the movement of the reflection plate.

FIG. 8 is a schematic diagram showing another example of a reflection plate.

FIG. 9 is a schematic diagram showing the configuration of a projector according to an embodiment of the present invention.

### BEST MODE FOR CARRYING OUT THE INVENTION

Next, an embodiment of the present invention will be described with reference to the drawings.

### First Embodiment

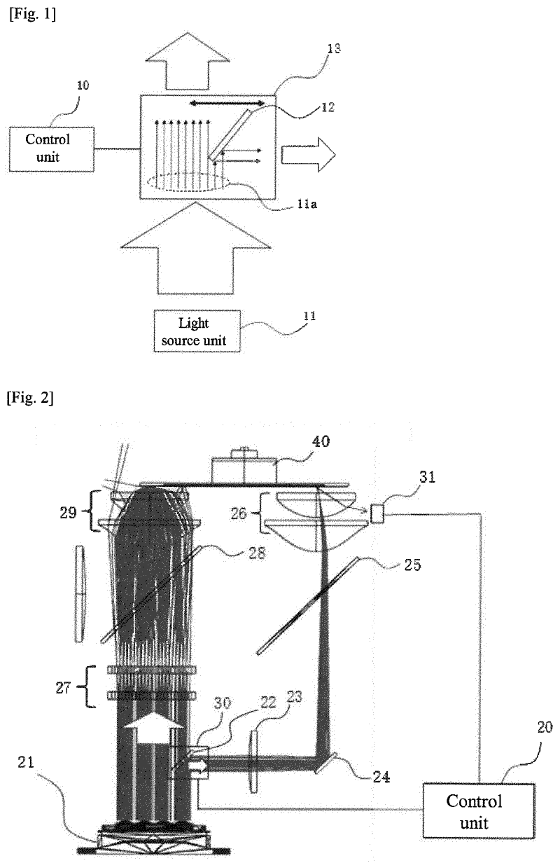

FIG. 1 is a block diagram showing the configuration of a light source device according to a first embodiment of the present invention. Note that, in FIG. 1, the optical paths and the optical elements are schematically illustrated, and the size, the shape, and the like may be different from an actual example.

Referring to FIG. 1, the light source device includes control unit 10, light source unit 11, reflection plate 12, and holding unit 13. Light source unit 11 emits monochromatic light. Light source unit 11 may be, for example, a laser light source. The laser light source may comprise a plurality of laser modules, each module including a plurality of laser diode (LD) chips mounted thereon. For example, a blue LD may be used as the laser module.

Reflection plate 12 reflects a part of emitted light 11a from light source unit 11. Holding unit 13 holds reflection plate 12 so as to be movable in a direction intersecting the optical path of the emitted light 11a. Holding unit 13 may be constituted by, for example, a one-dimensional moving stage that moves reflection plate 12 in one direction, or may be constituted by a two-dimensional moving stage (so-called XY stage) that moves reflection plate 12 in two directions perpendicular to each other.

Control unit 10 moves reflection plate 12 to adjust the quantity of the reflected light that is a part of emitted light 11a reflected by reflection plate 12.

According to the light source device of the present embodiment, reflection plate 12 acts to divide emitted light 11a of light source unit 11 into a first light beam and a second light beam. Here, the first light beam is, of emitted light 11a, light (reflected light) reflected by reflection plate 12. The second light beam is, of emitted light 11a, light that has not entered reflection plate 12. When reflection plate 12 moves in a direction intersecting the optical path of emitted light 11a, the ratio of the quantity of light between the first light beam (reflected light) and the second light beam changes. Therefore, it is possible to adjust the color tone of the output light of the light source device. For example, when converting the second light beam into fluorescent light and synthesizing the fluorescent light and the first light beam into one optical path to output the synthesized light, the color tone of the output light can be adjusted by moving reflection plate 12.

In addition, in a case in which light source unit 11 includes a plurality of laser modules, light source unit 11 must be designed such that the ratio of the number of LD chips between the first light beam and the second light beam is a predetermined number. However, since the number of LD chips can be set only on a module-by-module basis, the degree of freedom of design is low. According to the light source device of the present embodiment, the ratio of the number of LD chips between the first light beam and the second light beam can be freely set by moving reflection plate 12. Therefore, the degree of freedom of design is improved, and the number of LD chips can be optimized.

In the light source device of the present embodiment, the configuration shown in FIG. 1 is an example, and can be changed as appropriate.

For example, reflection plate 12 may include a reflection part and a transmission part that are adjacent to each other in a in-plane direction. The transmission part is transmissive to the wavelength of emitted light 11a. Holding unit 13 holds at least the transmission part such that the reflection part is inserted into the optical path of emitted light 11a. According to this configuration, holding unit 13 can hold reflection plate 12 without blocking emitted light 11a.

In the above case, the reflection part may have a rectangular shape, and the transmission part may be provided along two adjacent side parts of the reflection part. According to this configuration, holding unit 13 can hold reflection plate 12 with high accuracy without blocking emitted light 11a.

Furthermore, reflection plate 12 may be movable in first and second directions that are orthogonal to the optical path of emitted light 11a and orthogonal to each other.

In the light source device of the present embodiment, the light source device may further include a diffusion plate that diffuses the first light beam, which is the reflected light from reflection plate 12, and an optical sensor that detects a part of the diffused light from the diffusion plate, and control unit 10 may move reflection plate 12 such that the output value of the optical sensor becomes a predetermined value. According to this configuration, the quantity of the reflected light from reflection plate 12 can be maintained at a constant value.

Further, the light source device of the present embodiment may include: a diffusion plate that diffuses the first light beam that is the reflected light from reflection plate 12; a phosphor unit that converts the second light beam, that is, of emitted light 11a from light source unit 11, the light beam excluding the reflected light, into fluorescent light; and a color-synthesizing unit that synthesizes a light beam, that is the diffused light from the diffusion plate, and a light beam, that is the fluorescent light from the phosphor unit, into one optical path. In this case, control unit 10 may adjust the color tone of light emitted from the color-synthesizing unit by moving reflection plate 12. Here, the diffusion plate may be a reflective diffusion plate or a transmissive diffusion plate.

In the above case, an optical sensor may be further provided that detects a part of a predetermined colored beam among a plurality of colored beams that are separated from light emitted from the color-synthesizing unit. In this case, control unit 10 moves reflection plate 12 such that the output value of the optical sensor becomes a predetermined value.

Further, a projector may be provided that includes the light source device of the present embodiment described above, a light modulation unit that modulates the emitted light from the light source device to form an image, and a projection lens that projects the image formed by the light modulation unit.

Further, a control method of the light source device described above may be provided in which the quantity of the reflected light, which is a part of emitted light 11a reflected by reflection plate 12, is measured, and reflection plate 12 is moved such that the measured value of the quantity becomes a predetermined value.

Further, a program may be provided that causes a computer of the above-described light source device to execute steps of: measuring the quantity of reflected light that is a part of emitted light 11a reflected by reflection plate 12, and moving reflection plate 12 such that the measured value of the quantity becomes a predetermined value. The program may be provided on a computer-usable or computer-readable medium (also referred to as a recording medium), or may be provided via a network such as the Internet. Here, the computer-usable or computer-readable medium includes a medium capable of recording or reading information using magnetism, optics, electronics, electromagnetism, infrared rays, or the like. Such a medium includes, for example, a semiconductor memory, a semiconductor or solid-state memory, a magnetic tape, a removable computer disk, a random-access memory (RAM), a read-only memory (ROM), a magnetic disk, an optical disk, a magneto-optical disk, and the like.

### Second Embodiment

FIG. 2 is a diagram schematically showing the configuration of a light source device according to a second embodiment of the present invention. Note that, in FIG. 2, the optical paths and the optical elements are schematically illustrated, and the size, the shape, and the like may be different from an actual example.

The light source device illustrated in FIG. 2 includes control unit 20, laser light source unit 21, reflection plates 22, 24, and 25, condenser lens 23, collimator lenses 26 and 29, MLA (Micro Lens Array) 27, dichroic mirror 28, holding unit 30, optical sensor 31, and phosphor wheel 40.

Laser light source unit 21 includes a plurality of laser modules. Each laser module is equipped with a plurality of LD chips. The number of LD chips to be mounted on one laser module is, for example, 20 or 24. Here, blue LDs are used. Each laser module emits a blue laser beam in the same direction. The blue laser beam emitted from each laser module is a parallel light beam.

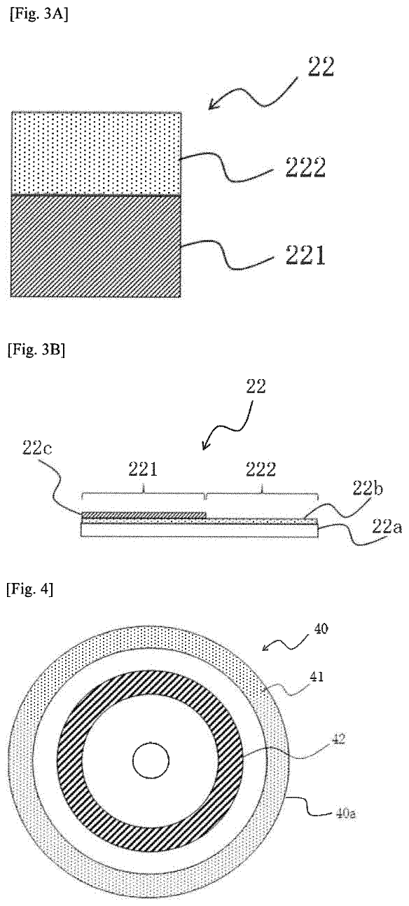

Reflection plate 22 reflects apart of the light emitted from laser light source unit 21. FIG. 3A illustrates a front view of reflection plate 22 and FIG. 3B illustrates a cross-sectional view of reflection plate 22. As shown in FIGS. 3A and 3B, reflection plate 22 includes reflection part 221 and transmission part 222. Antireflection film 22b is formed on glass-substrate 22a, and reflection film 22c is formed on antireflection film 22b in an area that is to be reflection part 221. Reflection film 22c is not formed on antireflection film 22b in the area that is to be transmission part 222. Reflection film 22c and antireflection film 22b may be vapor-deposited films or coating films.

Referring again to FIG. 2. holding unit 30 holds reflection plate 22 so as to be movable in a direction intersecting the optical path of light emitted from laser light source unit 21. Specifically, holding unit 30 holds transmission part 222 so that reflection part 221 is inserted into the optical path of light emitted from laser light source unit 21. Holding unit 30 includes, for example, a one-dimensional moving stage or a two-dimensional moving stage (XY stage).

Of the emitted light from laser light source unit 21, the blue laser beam reflected by reflection part 221 of reflection plate 22 is irradiated to phosphor wheel 40 via condenser lens 23, reflection plates 24 and 25, and collimator lens 26. On the other hand, of the emitted light from laser light source unit 21, the blue laser beam that does not enter reflection part 221 of reflection plate 22 is used as excitation light. The excitation light is irradiated to phosphor wheel 40 via MLA 27, dichroic mirror 28, and collimator lens 29.

FIG. 4 shows an example of phosphor wheel 40. As shown in FIG. 4, phosphor wheel 40 includes rotating substrate 40a on which phosphor layer 41 and reflective diffusion plate 42 are formed on the same plane. Phosphor layer 41 is formed in an annular shape along the circumferential direction in a region on the outer peripheral side. Reflective diffusion plate 42 is formed in an annular shape along the circumferential direction in a region on the inner peripheral side, that is, in a region inside phosphor layer 41.

The blue laser beam is incident to reflective diffusion plate 42 via reflection plate 25 and collimator lens 26. Reflective diffusion plate 42 reflects and diffuses the blue laser beam. Reflective diffusion plate 42 is an existing diffuser. For example, if rotating substrate 40a is a glass substrate, reflective diffusion plate 42 may be formed by laminating a reflection layer and a diffusion layer on the glass substrate. Further, reflective diffusion plate 42 may be a configuration in which uneven processing for diffusing light is performed on one surface of the glass substrate and a metal reflective film is further deposited on the other surface of the glass substrate. If rotating substrate 40a is formed of a metallic substrate or the like, reflective diffusion plate 42 may be formed by uneven processing for diffusing light on one surface of the substrate.

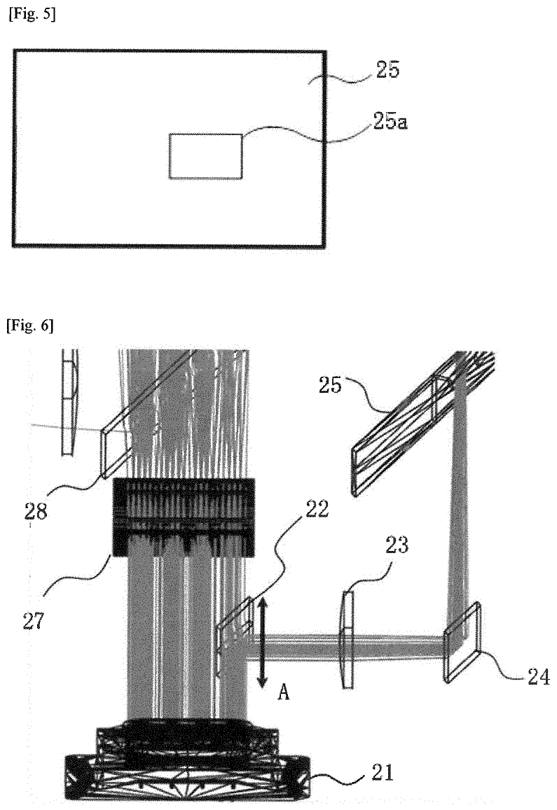

FIG. 5 shows an example of reflection plate 25. As illustrated in FIG. 5, reflection plate 25 includes through-hole 25a through which the reflected light from reflection plate 22 passes. In view of the movement of reflection plate 22, the shape and size of through-hole 25a are set so as not to block the reflected light (blue laser beam) from reflection plate 22. Specifically, when reflection plate 22 moves, the beam diameter of the reflected light from reflection plate 22 changes. The shape and size of through-hole 25a are determined in accordance with the largest variation of the beam diameter.

The reflected light (blue laser beam) from reflection plate 22 passes through through-hole 25a and enters reflective diffusion plate 42 through collimator lens 26. The blue diffused light, which is the reflected light emitted from reflective diffusion plate 42, enters reflection plate 25 via collimator lens 26. Collimator lens 26 converts the blue diffused light into a parallel light beam. The collimated blue diffused light enters the reflection area including through-hole 25a of reflection plate 25. Reflection plate 25 reflects the blue diffused light toward dichroic mirror 28.

The excitation light enters phosphor layer 41 through MLA 27, dichroic mirror 28, and collimator lens 29. Phosphor layer 41 includes a phosphor that emits yellow fluorescent light. Between phosphor layer 41 and rotating substrate 40a, a reflection member is provided that reflects the fluorescent light made incident from phosphor layer 41 toward phosphor layer 41. Alternatively, since rotating substrate 40a is made of a metallic material, the reflective member can be omitted. MLA 306 is a light-uniformizing element for realizing uniform illumination distribution on the illuminated surface of phosphor layer 41.

The yellow fluorescent light emitted from phosphor layer 41 is incident on one surface of dichroic mirror 28 via collimator lens 29. Collimator lens 29 collimates the yellow fluorescent light. The blue diffused light reflected by reflection plate 25 enters the other surface of dichroic mirror 28. Dichroic mirror 28 has a characteristic of transmitting, of light in the visible light wavelength range, light in the blue wavelength range and reflecting light in other wavelength ranges. Dichroic mirror 28 color-synthesizes the yellow fluorescent light and the blue diffused light into one optical path. The color-synthesized light is the output light of the light source device of the present embodiment.

Optical sensor 31 is disposed in the vicinity of collimator lens 26. Optical sensor 31 detects a part of the blue diffused light (the leaked light part) emitted from reflective diffusion plate 42.

Control unit 20 includes, for example, a computer such as a CPU (Central Processing Unit). Control unit 20 controls the movement of reflection plate 22 in holding unit 30 such that the output value of optical sensor 31 becomes a predetermined value. For example, when holding unit 30 is a one-dimensional moving stage or a two-dimensional moving stage, the amount of movement and the direction of movement of reflection plate 22 are controlled by controlling the amount of rotation and the direction of rotation of a motor (for example, a stepping motor). Since the motor control of the moving stage is a well-known technique, detailed description thereof will be omitted here.

FIG. 6 is a perspective view schematically showing directions of movement of reflection plate 22. In the example of FIG. 6, reflection plate 22 is moved in the up-down directions (arrow A in FIG. 6). When reflection plate 22 moves in the upward direction, the quantity of reflected light increases. Conversely, when reflection plate 22 moves in the downward direction, the quantity of reflected light decreases.

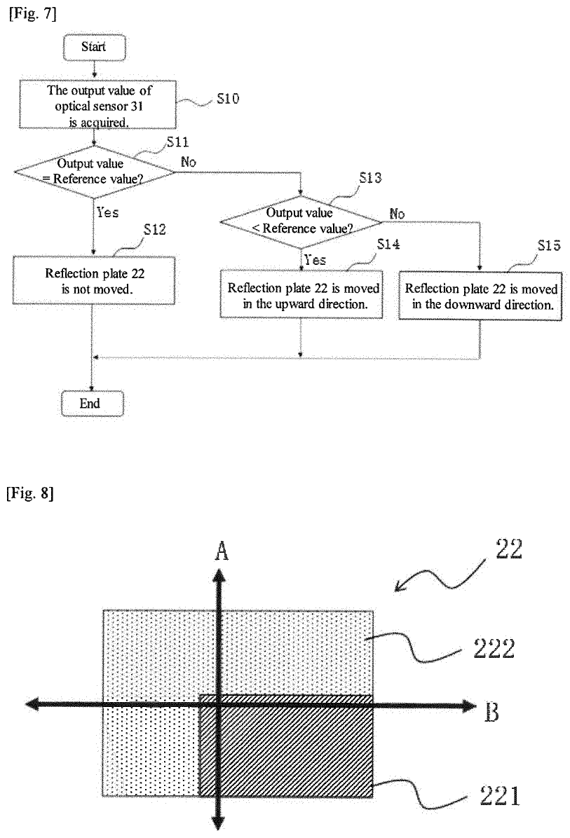

FIG. 7 is a flowchart showing the procedure of the movement control of reflection plate 22.

Referring to FIG. 7, in step S10, control unit 20 acquires the output value of optical sensor 31. In step S11, control unit 20 determines whether or not the output value of optical sensor 31 acquired in step S11 is the reference value. If the determination result is “Yes,” control unit 20 in step S12 maintains the present position of reflection plate 22 without moving reflection plate 22.

When the determination result of step S11 is “No,” control unit 20 in step S13 determines whether or not the output value of optical sensor 31 acquired in step S11 is smaller than the reference value. If the determination result is “Yes,” control unit 20 in step S14 moves reflection plate 22 in the upward direction by a predetermined amount. On the other hand, if the determination result of step S13 is “No,” control unit 20 in step S15 moves reflection plate 22 in the downward direction by a predetermined amount.

Control unit 20 repeats the process of the above-described steps S10-S15 at predetermined intervals so that the output value of optical sensor 31 gradually approaches the reference value. As a result, the output value of optical sensor 31 converges upon the reference value.

According to the above-described movement control of reflection plate 22, by effecting control such that the output value of optical sensor 31 becomes the reference value, the reflected light of reflection plate 22 can be maintained at a predetermined quantity of light. Therefore, it is possible to suppress changes in the color tone of light (yellow fluorescent light+blue diffused light) that is color-synthesized by dichroic mirror 28, that is, the color tone of the output light of the light source device.

Further, by moving reflection plate 22, it is possible to freely set the ratio of the number of LD chips between the first light beam directed toward reflective diffusion plate 42 and the second light beam directed toward phosphor layers 41. Therefore, as in the first embodiment, the flexibility of design is improved, and the number of LD chips can be optimized.

Note that the movement control of reflection plate 22 illustrated in FIG. 7 can be realized by executing a program by the computer that is control unit 20. In this case, the program may be provided on the aforementioned computer-usable or computer-readable medium (also referred to as a recording medium), or may be provided via a network such as the Internet.

Reflection plate 22 may have the structure shown in FIG. 8. In the example of FIG. 8, transmission part 222 is provided along two adjacent side parts of rectangular reflection part 221. Holding unit 30 holds transmission part 222 such that reflection plate 22 is movable in the directions of arrows A and B that are orthogonal to each other and that are orthogonal to the optical path of light emitted from laser light source 21. Here, arrow A corresponds to the up-down directions, and arrow B corresponds to the left-right directions. When reflection plate 22 moves in the upward direction, the quantity of reflected light increases, and conversely, when reflection plate 22 moves in the downward direction, the quantity of reflected light decreases. When reflection plate 22 moves in one of the left and right directions (the first direction), the quantity of reflected light increases, and conversely, when reflection plate 22 moves in the other of the left and right directions (the second direction), the quantity of reflected light decreases. For example, in the control sequence shown in FIG. 7, in step S14, reflection plate 22 is moved in the upward direction, in the first direction, or in both directions. Further, in step S15, reflection plate 22 is moved in the downward direction, in the second direction, or in both directions.

Note that the light source device of the first or second embodiment may include an operation unit including a plurality of operation keys, and control unit 10 (20) may receive an instruction signal indicating a direction of movement and an amount movement of reflection plate 12 (22) via the operation unit. Control unit 10 (20) may then move reflection plate 12 (22) in accordance with the instruction signal. According to this configuration, the user can adjust the color tone of the output light using the operation unit.

Each of the light source devices of the first and second embodiments described above can be used as a light source device of a projector. The projector includes an optical modulation unit that modulates emitted light of the light source device to form an image, and a projection lens that projects the image formed by the optical modulation unit.

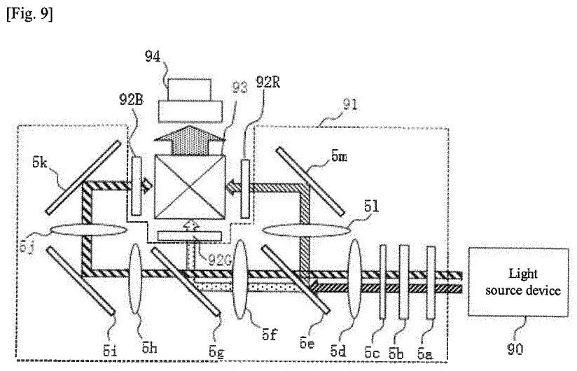

FIG. 9 schematically illustrates the configuration of a projector according to an embodiment of the present invention. The projector includes light source device 90, illumination optical system 91, three optical modulators 92R, 92G, and 92B, cross-dichroic prism 93, and projection lens 94. Light source device 90 is the light source device described in either of the first and second embodiments and emits white light including yellow fluorescent light and blue light.

Illumination optical system 91 separates the white light emitted from light source device 90 into red light for illuminating optical modulator 92R, green light for illuminating optical modulator 92G, and blue light for illuminating optical modulator 92B. Each of optical modulators 92R, 92G, and 92B includes a liquid crystal panel that modulates light to form an image.

Illumination optical system 91 includes fly-eye lenses 5a and 5b, polarization converter 5c, superimposing lens 5d, dichroic mirrors 5e and 5g, field lenses 5f and 5l, relay lenses 5h and 5j, and mirrors 5i, 5k, and 5m. The white light emitted from light source device 90 enters dichroic mirror Se via fly-eye lenses 5a and 5b, polarization converter 5c, and superimposing lens 5d.

Fly-eye lenses 5a and 5b are arranged to face each other. Each of fly-eye lenses 5a and 5b comprises a plurality of microlenses. Each microlens of fly-eye lens Sa faces a respective microlens of fly-eye lens 5b. In fly-eye lens Sa, the emitted light from light source device 90 is divided into a plurality of light beams corresponding to the number of the microlenses. Each microlens has a similar shape to that of the effective-display region of the liquid crystal panel and condenses the light beam from light source device 90 in the vicinity of fly-eye lens 5b.

Superimposing lens 5d and field lens 5l direct the principal ray from each microlens of fly-eye lens Sa toward the center of the liquid crystal panel of optical modulator 92R, and superimpose an image of each microlens on the liquid crystal panel. Similarly, superimposing lens 5d and field lens 5f direct the principal ray from each microlens of fly-eye lens 2a toward the center of each liquid crystal panel of light modulators 92G and 92B, and superimpose an image of each microlens on the liquid crystal panel.

Polarization converter 5c aligns the polarization direction of light that has passed through fly-eye lenses 5a and 5b with P-polarized light or S-polarized light. Dichroic mirror Se has a characteristic of reflecting, of visible light, light in the red wavelength range and transmitting light in wavelength ranges other than the red wavelength range.

Light (red) reflected by dichroic mirror Se is irradiated to the liquid crystal panel of optical modulator 92R via field lens 5l and mirror 5m. On the other hand, light (blue and green) transmitted through dichroic mirror 5e enters dichroic mirror Sg through field lens 5f. Dichroic mirror 5g has a characteristic of reflecting, of visible light, light in the green wavelength range and transmitting light in wavelength ranges other than the green wavelength range.

Light (green) reflected by dichroic mirror Sg is irradiated to the liquid crystal panel of optical modulator 92G. On the other hand, light (blue) transmitted through dichroic mirror 5g is irradiated to the liquid crystal panel of optical modulator 92B via relay lens 5h, mirror 5i, relay lens 5j, and mirror 5k.

Optical modulator 92R forms a red image. Optical modulator 92G forms a green image. Optical modulator 92B forms a blue image. Cross-dichroic prism 93 has first to third incident surfaces and an exit surface. In cross-dichroic prism 93, the red image light enters the first incident surface, the green image light enters the second incident surface, and the blue image light enters the third incident surface. The red image light, the green image light, and the blue image light are emitted from the emission surface on the same optical path.

The red image light, the green image light, and the blue image light emitted from the exit surface of cross-dichroic prism 93 are incident to projection lens 94. Projection lens 94 projects the red image, the green image, and the blue image onto a screen.

In the projector described above, the optical sensor may be provided on the side of mirror k that is opposite the optical modulator 92B side. In this case, mirror 5k transmits a part (several percent) of the blue light, and the optical sensor detects light transmitted through mirror 5k. Control unit 10 (20) moves reflection plate 12 (22) such that the output value of the optical sensor becomes a predetermined value (reference value).

Further, the optical sensor may be provided on the side of mirror 5m that is opposite the optical modulator 92R side. In this case, mirror 5m transmits a part (several percent) of the red light, and the optical sensor detects light transmitted through mirror 5m. Control unit 10 (20) moves reflection plate 12 (22) such that the output value of the optical sensor becomes a predetermined value (reference value).

### EXPLANATION OF REFERENCE NUMBERS

10 Control unit
11 Light source unit
11a Emitted light
12 Reflection plate
13 Holding unit

1. A light source device comprising:
a light source unit that emits monochromatic light;
a reflection plate that reflects a part of emitted light of the light source unit;
a holding unit that holds the reflection plate so as to be movable in a direction intersecting an optical path of the emitted light; and
a control unit that moves the reflection plate to adjust a quantity of reflected light that is the part of the emitted light reflected by the reflection plate.

2. The light source device according to claim 1, wherein the reflection plate includes a reflection part and a transmission part that are adjacent to each other in an in-plane direction, and the transmission part is transmissive to a wavelength of the emitted light of the light source unit, and the holding unit holds at least the transmission part so that the reflection part is inserted in the optical path of the emitted light.

3. The light source device according to claim 2, wherein the reflection part has a quadrangular shape, and the transmission part is provided along two adjacent side parts of the reflection part.

4. The light source device according to claim 1, wherein the reflection plate is movable in first and second directions that are orthogonal to the optical path of the emitted light and that are orthogonal to each other.

5. The light source device according to claim 1, further comprising:
a diffusion plate that diffuses a first light beam which is the reflected light of the reflection plate; and
an optical sensor that detects a part of diffused light from the diffusion plate,
wherein the control unit moves the reflection plate such that an output value of the optical sensor becomes a predetermined value.

6. The light source device according to claim 1, further comprising:
a diffusion plate that diffuses a first light beam which is the reflected light of the reflection plate;
a phosphor unit that converts, of the emitted light of the light source unit, a second light beam which is a light beam excluding the reflected light, into fluorescent light; and
a color-synthesizing unit that synthesizes a light beam that consists of diffused light from the diffusion plate and a light beam that consists of the fluorescent light from the phosphor unit into one optical path,
wherein the control unit moves the reflection plate to adjust a color tone of light emitted from the color-synthesizing unit.

7. The light source device according to claim 6, further comprising an optical sensor that detects a part of a predetermined colored light beam among a plurality of colored light beams that are separated from the emitted light of the color-synthesizing unit, wherein the control unit moves the reflection plate such that an output value of the optical sensor becomes a predetermined value.

8. A projector comprising:
a light source device according to claim 1;
an optical modulator that modulates the emitted light of the light source device to form an image; and
a projection lens that projects an image formed by the optical modulator.

9. A method of controlling a light source device that includes a reflection plate that reflects a part of emitted light from a light source unit that emits monochromatic light, wherein the reflection plate is moved in a direction intersecting an optical path of the emitted light, said method comprising:
measuring a quantity of reflected light that is the part of the emitted light reflected by the reflection plate; and
moving the reflection plate such that a measured value of the quantity becomes a predetermined value.

10. A computer-readable recording medium recorded with a program for causing a computer of a light source device that is provided with a reflection plate that reflects a part of emitted light from a light source unit that emits monochromatic light wherein the reflection plate is moved in a direction intersecting an optical path of the emitted light, to execute the steps of:
measuring a quantity of reflected light that is the part of the emitted light reflected by the reflection plate; and
moving the reflection plate such that a measured value of the quantity becomes a predetermined value.

11. The light source device according to claim 2, wherein the reflection plate is movable in first and second directions that are orthogonal to the optical path of the emitted light and that are orthogonal to each other.

12. The light source device according to claim 3, wherein the reflection plate is movable in first and second directions that are orthogonal to the optical path of the emitted light and that are orthogonal to each other.

13. The light source device according to claim 2, further comprising:
a diffusion plate that diffuses a first light beam which is the reflected light of the reflection plate; and
an optical sensor that detects a part of diffused light from the diffusion plate,
wherein the control unit moves the reflection plate such that an output value of the optical sensor becomes a predetermined value.

14. The light source device according to claim 3, further comprising:
a diffusion plate that diffuses a first light beam which is the reflected light of the reflection plate; and
an optical sensor that detects a part of diffused light from the diffusion plate,
wherein the control unit moves the reflection plate such that an output value of the optical sensor becomes a predetermined value.

15. The light source device according to claim 2, further comprising:
a diffusion plate that diffuses a first light beam which is the reflected light of the reflection plate;
a phosphor unit that converts, of the emitted light of the light source unit, a second light beam which is a light beam excluding the reflected light, into fluorescent light; and
a color-synthesizing unit that synthesizes a light beam that consists of diffused light from the diffusion plate and a light beam that consists of the fluorescent light from the phosphor unit into one optical path,
wherein the control unit moves the reflection plate to adjust a color tone of light emitted from the color-synthesizing unit.

16. The light source device according to claim 3, further comprising:
a diffusion plate that diffuses a first light beam which is the reflected light of the reflection plate;
a phosphor unit that converts, of the emitted light of the light source unit, a second light beam which is a light beam excluding the reflected light, into fluorescent light; and
a color-synthesizing unit that synthesizes a light beam that consists of diffused light from the diffusion plate and a light beam that consists of the fluorescent light from the phosphor unit into one optical path,
wherein the control unit moves the reflection plate to adjust a color tone of light emitted from the color-synthesizing unit.

17. The light source device according to claim 15, further comprising an optical sensor that detects a part of a predetermined colored light beam among a plurality of colored light beams that are separated from the emitted light of the color-synthesizing unit,
wherein the control unit moves the reflection plate such that an output value of the optical sensor becomes a predetermined value.

18. The light source device according to claim 16, further comprising an optical sensor that detects a mart of a predetermined colored light beam among a plurality of colored light beams that are separated from the emitted light of the color-synthesizing unit,
wherein the control unit moves the reflection plate such that an output value of the optical sensor becomes a predetermined value.

19. A projector comprising:
a light source device according to claim 2;
an optical modulator that modulates the emitted light of the light source device to form an image; and
a projection lens that projects an image formed by the optical modulator.

20. A projector comprising:
a light source device according to claim 3;
an optical modulator that modulates the emitted light of the light source device to form an image; and
a projection lens that projects an image formed by the optical modulator.
